(19) United States
(12) Patent Application Publication
(10) Pub. No.: US 2006/0147732 A1
(43) Pub. Date: Jul. 6, 2006

(54) Metal plate, method for making same and method for folding same

(76) Inventors: Alfred Chocroun, Sucy En Brie (FR); Jean-Claude Jeandeaud, Saint Marcel Bel Accueil (FR)

Correspondence Address: Ralph A. Dowell of DOWELL & DOWELL P.C., 2111 Eisenhower Ave, Suite 406, Alexandria, VA, 22314, US

(21) Appl. No.: 10/521,562

(22) PCT Filed: Jul. 18, 2003
(86) PCT No.: PCT/FR03/02284

§ 371 Date: Jul. 22, 2005

(30) Foreign Application Priority Data
Jul. 19, 2002 (FR) 0209225

(51) Int. Cl. B60R 13/08

(52) U.S. Cl. 428/457; 428/595

(57) ABSTRACT

The invention concerns a metal plate (1) comprising a peripheral edge (4), and opposite first (2) and second (3) surfaces. At least one sheaf (5) of several assembled rectilinear mutually parallel grooves (6, 7, 8) obtained by pressing, linking together two portions of said peripheral edge (4) and delimited each by a wall with globally dihedral shape is provided in said first surface (2) of the metal plate (1). Said metal plate is designed to be folded along the sheaf (5) of grooves.

The present invention relates to a metal plate, as well as to a method for making and to a method for folding such a metal plate.

It is known to make for example a cabinet for electrical equipment or a protective casing or a furnishing element, by folding an initially flat metal plate one or more times.

Folding of the metal plate is effected in the factory and controlled by qualified personnel, since, at the present time, it requires the use of a heavy machine, such as a roller profiler or a press, which constitutes a drawback.

French Patent 2 776 547 teaches producing a line of successive perforations in a plate, then folding this plate along the line of perforations. However, the presence of perforations in the object produced from the metal plate renders this object fragile and proves prohibitory in the majority of applications.

In British Patent Application GB-2 197 810, there is described a metal plate which is intended to be folded along a sheaf of rectilinear, parallel grooves, made by pressing. These grooves each comprise a flat bottom, with the result that they cannot be made by pressing without the metal of the plate being locally crushed, i.e. without there being work-hardening of this metal. Work-hardening of the metal, more particularly at the base of the grooves, results, in the majority of cases, in the plate breaking when it is folded along the sheaf of grooves, unless it is consented that the radius of curvature at the level of the fold be very large.

In Japanese Patent Application JP-60 046819, it is question of a metal plate in which is formed a groove with V-shaped cross section. This plate is folded along the groove. According to tests made by the Applicants, it does not appear possible that the plate does not break when it is thus folded.

The invention, which intends to overcome the aforementioned drawback, therefore has at least for object to facilitate folding of a metal plate.

To that end, the invention has for its object a metal plate comprising a peripheral edge, as well as opposite first and second surfaces, characterized in that at least one sheaf of a plurality of grooves obtained by pressing, which are rectilinear, parallel to one another, grouped, linking together two portions of said peripheral edge and each delimited by a wall of globally dihedral shape, is made in said first surface of the metal plate.

According to other advantageous characteristics of this metal plate:
the or each pair of consecutive grooves of said sheaf delimits a band of the plate, this band being convex towards said second surface.
one of the dihedra comprises a first surface which is located more towards the inside of the sheaf than the second surface of this dihedron, the angle formed by the first surface of the dihedron and a plane globally perpendicular to the plate being smaller than the angle formed by the second surface of the dihedron and said plane.
each of the grooves of the sheaf contains an adhesive, at least a portion of the first surface of the plate being coated with a sealing film laterally obturating these grooves.
it is folded along the sheaf of grooves, the two surfaces of each dihedron being glued together.

The invention also relates to a method for making a plate such as defined hereinabove, characterized in that it comprises a step in which:
(a) the sheaf of a plurality of grooves is made by pressing the plate between a first element and a second element which bears a sheaf of a plurality of ribs for forming the grooves.

According to other advantageous characteristics of this method of making, said band is rendered convex towards the second surface of the plate by effecting step (a), the first element bearing at least one groove for forming said band.

In addition, the invention has for its object a method for folding a metal plate, characterized in that the metal plate is such as defined hereinabove and in that it comprises a step in which:
(b) in the plate, a fold is formed along the sheaf of grooves, so that these grooves and the concavity of the fold are on the same side of the plate.

According to other advantageous characteristics of this method of folding:
step b) is effected manually;
before step (b), an adhesive is applied to the inside of each of the grooves of the sheaf;
before step (b), it comprises a method of making as defined hereinabove.

The invention will be more readily understood on reading the following description given solely by way of example and made with reference to the accompanying drawings, in which:

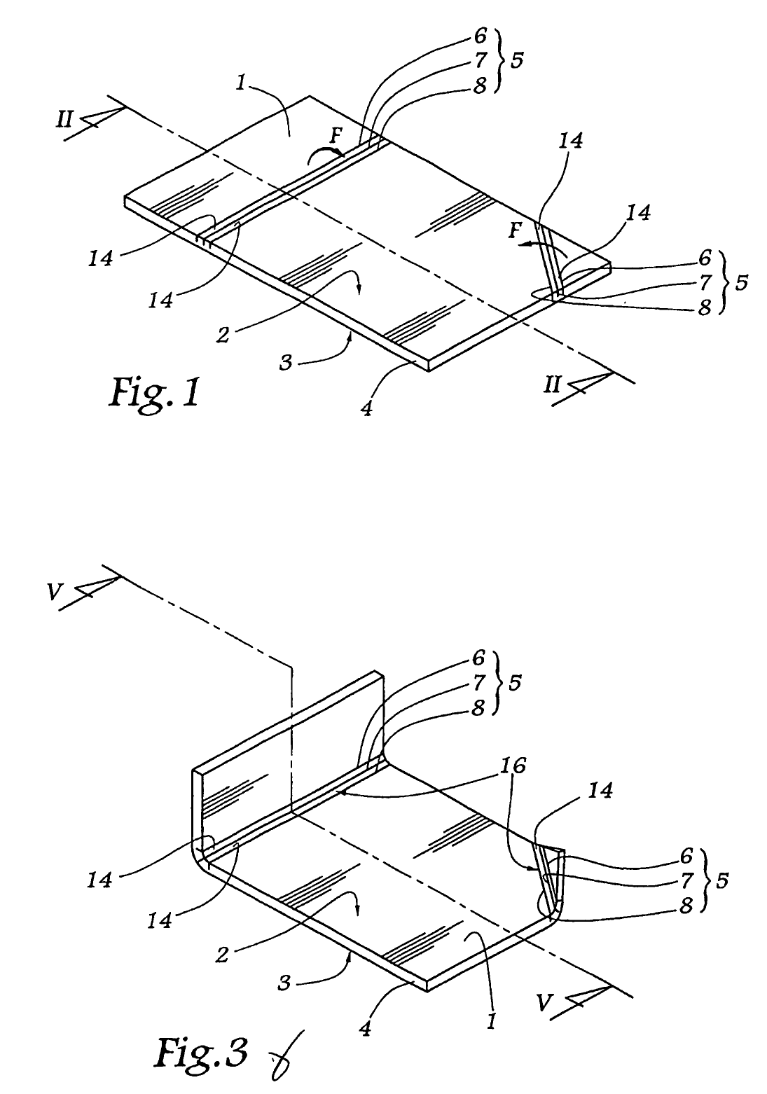

FIG. 1 is a view in perspective of a metal plate according to the invention.

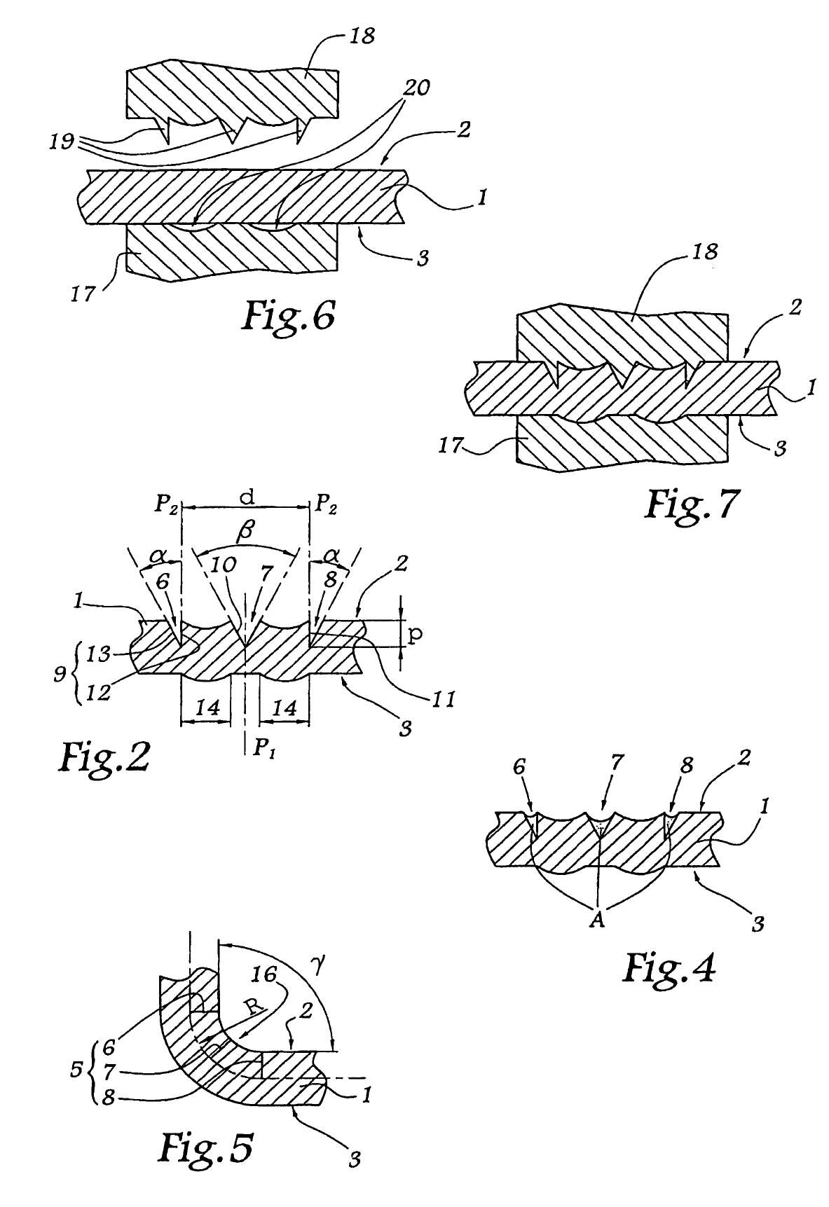

FIG. 2 is a partial view, in section along line II-II of FIG. 1.

FIG. 3 is a view in perspective of the metal plate of FIGS. 1 and 2 after folding.

FIG. 4 is a view similar to FIG. 2 and illustrates a step of the method of folding the plate shown in this FIG. 2.

FIG. 5 is a partial view, in section along line V-V of FIG. 3.

FIGS. 6 and 7 are two views similar to FIG. 2 and respectively illustrate two steps of a method according to the invention for making the plate shown in FIGS. 1 to 5; and

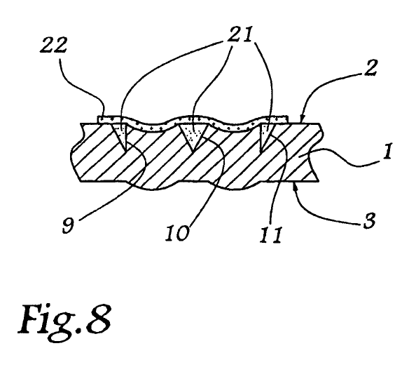

FIG. 8 is a view similar to FIG. 2 and represents a metal plate in accordance with a variant embodiment of the invention.

FIGS. 1 and 2 represent a metal plate 1 which is planar and comprises two opposite surfaces 2 and 3, as well as a peripheral edge 4.

The plate 1 bears two sheaves 5 of rectilinear grooves, made in the surface 2. In the example shown, the grooves of the same sheaf 5 are three in number and are respectively referenced 6, 7 and 8. They are parallel to one another and join together two portions of the peripheral edge 4.

Each of these grooves 6, 7 and 8 is delimited by a wall 9, 10 or 11, of globally dihedral shape. Like each sheaf 5, each central groove 7, which extends between the lateral grooves 6 and 8 of the same sheaf 5 as itself, is symmetrical with respect to a plane P₁ perpendicular to the plate 1.

In each sheaf 5, one, referenced 12, of the two surfaces of the dihedron 9 which delimits the lateral groove 6 is closer to the central groove 7 than the other surface 13 of this dihedron 9. It extends along a plane P₂ globally perpendicular to the plate 1. On the other hand, the surface 13 and this plane P₂ form a non-zero angle α.

The groove 8 of a sheaf 5 is symmetrical with respect to the groove 6 of this sheaf 5, so that its shape is deduced from the foregoing.

The band 14 that the two consecutive grooves 6 and 7 of each sheaf 5 delimit in the plate 4 is convex towards the surface 3 and concave towards the surface 2. The same applies to the band 14 which extends between the two consecutive grooves 7 and 8 of each sheaf 5.

Just before folding the plate 1, an adhesive A is applied at the level of the sheaves 5, care being taken to cause this adhesive A to penetrate in the grooves 6, 7 and 8, after which the plate 1 is as illustrated in FIG. 4. Folding of the plate 1 is symbolized by arrows F shown in FIG. 1. This folding, after which the plate 1 is such as illustrated in FIGS. 3 and 5, is effected along each sheaf 5, so that the concavity of the folds 16 to which it leads is located on the same side of the plate 1 as the grooves 6, 7 and 8.

In accordance with the object of the invention, each sheaf 5 facilitates the folding of the plate 1. Tests have shown that the sheaves 5 render folding of the plate 1 so easy that it may be effected manually, for example by an individual assembling a piece of furniture which was sold to him in detached parts and of which plate 1 is intended to form part. Consequently, the plate 1 presents the advantage of being able to remain planar, therefore of small dimensions, as long as its transport up to its place of assembly has not been terminated.

When folding of the plate 1 is terminated, the grooves 6, 7 and 8 are closed, as may be seen in FIG. 5. The two surfaces of each of the dihedra 9, 10 and 11 are glued to one another, this rigidifying the plate 1 at the level of the folds 16 and opposing the straightening up of this plate 1.

Moreover, as each sheaf 5 comprises a plurality of grooves 6, 7 and 8, each fold 16 is constituted by a succession of elementary folds, of which each is formed along one of these grooves 6, 7 and 8. It follows that the deformation resulting from each folding is distributed between these elementary folds, so that the plate 1 is clearly more solid at the level of each fold 16 than if each sheaf 5 were replaced by a single groove 6, 7 or 8.

Before folding, the two surfaces of each of the dihedra 9, 10 and 11 form one of a plurality of angles α and β. The sum of the angles α and β which were located at the level of a sheaf 5 before folding, determines the angle γ that the two portions of the plate 1 separated by the fold 16 extending along this sheaf 5 form after folding.

The mean radius of curvature R of a fold 16 formed along a sheaf 5 depends on the depth p of the grooves 6, 7 and 8 of this sheaf, on the number of these grooves, equal to three in the example shown, and on the angle α or β that the two surfaces of the dihedron 9, 10 or 11 delimiting each of these grooves 6, 7 and 8 form. It also depends on the distance d which, before the folding, separates the two lateral grooves 6 and 8 of the sheaf 5. Advantageously, it is made so that the more this mean radius of curvature R is great, the more the number of grooves of the sheaf 5 is high.

In the example shown, the bands 14 define convex surfaces. If these surfaces were not convex, but, for example, planar, they would constitute facets after the folding. The shape of the convex surfaces that the bands 14 define is therefore determined so that, after folding of the plate 1, these facets are hardly or not perceptible to the naked eye.

Grooves 6, 7 and 8 of the same sheaf 5 and the bands 14 delimited by these grooves are imprinted simultaneously with the aid of the die 17 and punch 18 shown in FIGS. 6 and 7.

A sheaf of ribs 19 that the punch 18 bears has a cross section substantially complementary of each sheaf 5 of grooves.

The die 17 bears two grooves 20 of which each is intended to render a surface of a band 14 convex.

In FIG. 6, the plate 1 free of any relief has been positioned between the die 17 and the punch 18, which is displaced towards the die 17. The punch 18 is stopped as soon as it has attained the position illustrated in FIG. 7 and in which this punch 18 and the die 17 press the plate 1 between themselves in order to imprint a sheaf 5 of three grooves 6, 7 and 8, as well as each of the bands 14 delimited by these grooves.

The punch 18 is then spaced apart from the die 17, after which the plate 1 may be withdrawn.

In a variant, the punch 18 and the die 17 may be replaced by two rollers which press the plate 1 between themselves and of which each rolls on one of the two surfaces 2 and 3 of this plate 1.

During impression of a sheaf 5, each rib splits the metal of the plate 1 more than it crushes it. This is advantageous insofar as the crushing of a metal is accompanied by a work-hardening which renders this metal brittle.

The plate 1 shown in FIG. 8 is identical to that shown in FIG. 2, except that the grooves 6, 7 and 8 of each of its sheaves 5 contain an adhesive 21 and are laterally obturated by a sealing film 22 which covers a band of the surface 2 of the plate 1 and isolates this adhesive 21 from the atmospheric air.

Just before this plate 1 is folded, the sealing films 22 are withdrawn, after which the plate 1 is such as illustrated in FIG. 4.

The invention is not limited to the forms of embodiment described hereinabove. In particular, each of the lateral grooves 6 and 8 may be substantially symmetrical with respect to plane P₂ globally perpendicular to the plate 1. When such is the case, the grooves 6, 7 and 8 of each sheaf 5 may be globally identical.

1. Metal plate comprising a peripheral edge (4), as well as opposite first (2) and second (3) surfaces, characterized in that at least one sheaf (5) of a plurality of grooves (6, 7, 8) obtained by pressing, which are rectilinear, parallel to one another, grouped, linking together two portions of said peripheral edge (4) and each delimited by a wall of globally dihedral shape (9, 10, 11), is made in said first surface (2) of the metal plate.

2. Plate according to claim 1, characterized in that the or each pair of consecutive grooves of said sheaf (5) delimits a band (14) of the plate, this band (14) being convex towards said second surface (3).

3. Plate according to claim 1 characterized in that at least one of the dihedra (9, 11) comprises a first surface (12) which is located more towards the inside of the sheaf (5) than the second surface (13) of this dihedron (9, 11), the angle formed by the first surface (12) of the dihedron (9, 11) and a plane (P₂) globally perpendicular to the plate being smaller than the angle (α) formed by the second surface (13) of the dihedron (9, 11) and said plane (P₂).

4. Plate according to claim 1 characterized in that each of the grooves (6, 7, 8) of the sheaf (5) contains an adhesive (21), at least a portion of the first surface (2) of the plate being coated with a sealing film (22) laterally obturating these grooves (6, 7, 8).

5. Plate according to claim 1 characterized in that it is folded along the sheaf (5) of grooves (6, 7, 8), the two surfaces of each dihedron (9, 10, 11) being glued together.

6. Method for making a plate (1) according to claim 1 characterized in that it comprises a step in which:
(a) the sheaf (5) of a plurality of grooves (6, 7, 8) is made by pressing the plate between a first element (17) and a second element (18) which bears a sheaf of a plurality of ribs (19) for forming the grooves.

7. Method according to claim 6 characterized in that a band (14) is rendered convex towards the second surface (3) of the plate (1) by effecting step (a), the first element (17) bearing at least one groove (20) for forming said band (14).

8. Method for folding a metal plate, characterized in that the metal plate (1) is according to claim 1 in that it comprises a step in which:
(b) in the plate (1), a fold (16) is formed along the sheaf (5) of grooves (6, 7, 8), so that these grooves and the concavity of the fold (16) are on the same side of the plate (1).

9. Method according to claim 8, characterized in that step (b) is effected manually.

10. Method according to claim 9, characterized in that, before step (b), an adhesive (A; 21) is applied to the inside of each of the grooves (6, 7, 8) of the sheaf (5).

11. Method according to claim 8 characterized in that, before step (b), it comprises a step wherein the sheaf (5) of a plurality of grooves (6, 7, 8) is made by pressing the plate between a first element (17) and a second element (18) which bears a sheaf of a plurality of ribs (19) for forming the grooves.
